(19) United States
(12) Patent Application Publication
(10) Pub. No.: US 2026/0147242 A1
(43) Pub. Date: May 28, 2026

(54) DISPLAY PANEL HAVING LIGHT-TRANSMITTING AREA

(71) Applicant: GIANTPLUS TECHNOLOGY CO., LTD., Miaoli County (TW)

(72) Inventors: CHE-YAO WU, Taoyuan City (TW); KAI-JU CHOU, Taoyuan City (TW); CHIEN-CHI CHEN, Taoyuan City (TW); I-TA JIANG, Taoyuan City (TW)

(21) Appl. No.: 19/286,176

(22) Filed: Jul. 30, 2025

(30) Foreign Application Priority Data
Nov. 27, 2024 (TW) 113145686

(51) Int. Cl. G02F 1/1337; G02F 1/1335; G02F 1/1343

(52) U.S. Cl. CPC G02F 1/1337; G02F 1/133553; G02F 1/13439

(57) ABSTRACT

A display panel having a light-transmitting area includes a first flat layer, a first light-transmitting conductive layer, a reflective layer, a liquid crystal layer, a second light-transmitting conductive layer, a second flat layer, and two alignment films. The first light-transmitting conductive layer is disposed on the first flat layer. The reflective layer is disposed on the first light-transmitting conductive layer, and an area on the first light-transmitting conductive layer without the reflective layer defines a transmitting opening. The liquid crystal layer is disposed on the reflective layer and doped with chiral molecules. The second light-transmitting conductive layer is disposed on the liquid crystal layer. The two alignment films are respectively disposed between the reflective layer and the liquid crystal layer, and between the second light-transmitting conductive layer and the liquid crystal layer, and at least one alignment film applies a directional force to the liquid crystal in contact.

### CROSS-REFERENCE TO RELATED PATENT APPLICATION

This application claims the benefit of priorities to Taiwan Patent Application No. 113145686, filed on Nov. 27, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a display panel, and more particularly to a display panel having a light-transmitting area.

### BACKGROUND OF THE DISCLOSURE

In the relevant art, panels with vertically aligned liquid crystals usually have protrusions on the visible side of the panel to give the liquid crystals a uniform outward expansion force to control the initial positioning direction of the liquid crystals. However, when the liquid crystals encounter a light-transmitting area, the liquid crystals are not greatly affected by the protrusions and may undergo an unstable state. In addition, in some situations, the light-transmitting area may be covered by the protrusions, reducing the transmittance of the light-transmitting area.

Therefore, how to design a panel that improves the initial positioning ability of vertically aligned liquid crystals and the transmittance of light-transmitting areas has become an important issue to be addressed in the relevant art.

### SUMMARY OF THE DISCLOSURE

The purpose of the present disclosure is to provide a display panel having a light-transmitting area, including a first light-transmitting substrate, a first flat layer, a first light-transmitting conductive layer, a reflective layer, a liquid crystal layer, a second light-transmitting conductive layer, a second flat layer, a color filter, a second light-transmitting substrate, and two alignment films.

The first light-transmitting substrate has a top surface and a bottom surface, in which a thin film transistor array is disposed on the top surface. The first flat layer is disposed on the thin film transistor array. The first light-transmitting conductive layer is disposed on the first flat layer. The reflective layer is disposed on the first light-transmitting conductive layer, and a region of the first light-transmitting conductive layer without the reflective layer defines a transmitting opening. The liquid crystal layer includes a plurality of liquid crystals and is disposed on the reflective layer, in which chiral molecules are doped into the liquid crystal layer. The second light-transmitting conductive layer is disposed on the liquid crystal layer. The second flat layer is disposed on the second light-transmitting conductive layer. The color filter is disposed on the second flat layer. The second light-transmitting substrate is disposed on the color filter. The two alignment films are respectively disposed between the reflective layer and the liquid crystal layer, and between the second light-transmitting conductive layer and the liquid crystal layer. At least one of the alignment films has a pre-tilt angle to provide a first directional force to the plurality of liquid crystals in contact therewith.

According to one embodiment, the surface of the alignment film applying the first directional force toward the liquid crystal layer defines a contact surface. Each of the liquid crystals subjected to the first directional force forms a positioning angle with the contact surface, and a range of the positioning angle is from 70 to 110 degrees.

According to one embodiment, the other alignment film has another pre-tilt angle to provide a second directional force to the plurality of liquid crystals in contact therewith.

According to one embodiment, an alignment angle is formed between the first directional force and the second directional force, and the alignment angle is greater than or equal to 0 degrees and less than or equal to 180 degrees.

According to one embodiment, the width of the transmitting opening in the horizontal direction is greater than 2 μm.

According to one embodiment, the width of the transmitting opening in the horizontal direction is less than or equal to the length of the reflective layer.

According to one embodiment, a doping concentration of the chiral molecules is defined by a distance that each of the liquid crystals moves along the vertical direction when rotating 360 degrees with the vertical direction as the rotation axis, and a range of the distance is 1 to 100 μm.

According to one embodiment, the two alignment films respectively define a first alignment film and a second alignment film, the first alignment film is located between the second light-transmitting conductive layer and the liquid crystal layer, the first alignment film applies the first directional force, the first flat layer has a convex portion corresponding to the transmitting opening, in which a portion of the liquid crystal layer corresponding to the convex portion defines a first spacing in thickness in a vertical direction; and in which a portion of the liquid crystal layer corresponding to the reflective layer has a thickness in the vertical direction defining a second spacing, and a ratio of the first spacing to the second spacing is less than 1 and greater than or equal to 0.33.

According to one embodiment, the two alignment films respectively define a first alignment film and a second alignment film, the first alignment film is located between the second light-transmitting conductive layer and the liquid crystal layer, the first alignment film applies the first directional force, the first flat layer has a concave portion corresponding to the transmitting opening, in which a portion of the liquid crystal layer corresponding to the concave portion has a thickness in a vertical direction defining a first spacing; and in which a portion of the liquid crystal layer corresponding to the reflective layer defines a second spacing in thickness in the vertical direction, and the ratio of the first spacing to the second spacing is greater than 1 and less than or equal to 3.

According to one embodiment, the two alignment films respectively define a first alignment film and a second alignment film, the first alignment film is located between the second light-transmitting conductive layer and the liquid crystal layer, the first alignment film applies the first directional force, the second flat layer has a convex portion corresponding to the transmitting opening, in which a portion of the liquid crystal layer corresponding to the convex portion has a thickness in a vertical direction defining a first spacing; and in which a portion of the liquid crystal layer corresponding to the reflective layer defines a second spacing in thickness in the vertical direction, and the ratio of the first spacing to the second spacing is less than 1 and greater than or equal to 0.33.

According to one embodiment, the two alignment films respectively define a first alignment film and a second alignment film, the first alignment film is located between the second light-transmitting conductive layer and the liquid crystal layer, the first alignment film applies the first directional force, the second flat layer has a concave portion corresponding to the transmitting opening, in which a portion of the liquid crystal layer corresponding to the concave portion has a thickness in a vertical direction defining a first spacing; and in which a portion of the liquid crystal layer corresponding to the reflective layer defines a second spacing in thickness in the vertical direction, and a ratio of the first spacing to the second spacing is greater than 1 and less than or equal to 3.

According to one embodiment, the two alignment films respectively define a first alignment film and a second alignment film, the first alignment film is located between the reflective layer and the liquid crystal layer, the first alignment film applies the first directional force, the first flat layer has a convex portion corresponding to the transmitting opening, in which a portion of the liquid crystal layer corresponding to the convex portion has a thickness in a vertical direction defining a first spacing; and in which a portion of the liquid crystal layer corresponding to the reflective layer defines a second spacing in thickness in the vertical direction, and a ratio of the first spacing to the second spacing is less than 1 and greater than or equal to 0.33.

According to one embodiment, the two alignment films respectively define a first alignment film and a second alignment film, the first alignment film is located between the reflective layer and the liquid crystal layer, the first alignment film applies the first directional force, the first flat layer has a concave portion corresponding to the transmitting opening, in which a portion of the liquid crystal layer corresponding to the concave portion has a thickness in a vertical direction defining a first spacing; and in which a portion of the liquid crystal layer corresponding to the reflective layer defines a second spacing in thickness in the vertical direction, and the ratio of the first spacing to the second spacing is greater than 1 and less than or equal to 3.

According to one embodiment, the two alignment films respectively define a first alignment film and a second alignment film, the first alignment film is located between the reflective layer and the liquid crystal layer, the first alignment film applies the first directional force, the second flat layer has a convex portion corresponding to the transmitting opening, in which a portion of the liquid crystal layer corresponding to the convex portion has a thickness in a vertical direction defining a first spacing; and in which a portion of the liquid crystal layer corresponding to the reflective layer defines a second spacing in thickness in the vertical direction, and the ratio of the first spacing to the second spacing is less than 1 and greater than or equal to 0.33.

According to one embodiment, the two alignment films respectively define a first alignment film and a second alignment film, the first alignment film is located between the reflective layer and the liquid crystal layer, the first alignment film applies the first directional force, the second flat layer has a concave portion corresponding to the transmitting opening, in which a portion of the liquid crystal layer corresponding to the concave portion defines a first spacing in a thickness in a vertical direction; and in which a portion of the liquid crystal layer corresponding to the reflective layer defines a second spacing in thickness in the vertical direction, and the ratio of the first spacing to the second spacing is greater than 1 and less than or equal to 3.

One of the beneficial effects of the present disclosure is that the display panel having a light-transmitting area is based on the technical scheme in which “a reflective layer being disposed on the first light-transmitting conductive layer, and a region of the first light-transmitting conductive layer that is not covered by the reflective layer defining a transmission opening,” and “two alignment films being respectively disposed between the reflective layer and the liquid crystal layer, and between the second light-transmitting conductive layer and the liquid crystal layer, wherein at least one of the alignment films has a pre-tilt angle to apply a first directional force to the liquid crystals in contact therewith.” With such a configuration, even in an extremely narrow light-transmitting area, the initial alignment of the liquid crystals can be effectively controlled by the first directional force provided by the first alignment film. As a result, vertically aligned liquid crystal display panels no longer require protrusions for alignment, thereby overcoming the issue of poor alignment performance, especially for liquid crystals located within the transmission area. In addition, the configuration eliminates the problem of light obstruction caused by protrusions in the transmission area, thereby improving the transmittance of the panel.

Furthermore, the liquid crystal layer of the display panel having a light-transmitting area is doped with chiral molecules. By incorporating chiral molecules, the liquid crystals can exhibit stable rotational behavior.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a pixel in a display panel having a light-transmitting area according to one embodiment of the present disclosure;

FIG. 2 is a schematic cross-sectional view of the pixel shown in FIG. 1;

FIG. 3 is a schematic cross-sectional view of a display panel having a light-transmitting area according to one embodiment of the present disclosure;

FIG. 4 is a schematic cross-sectional view of a display panel having a light-transmitting area according to one embodiment of the present disclosure;

FIG. 5 is a schematic cross-sectional view of a display panel having a light-transmitting area according to one embodiment of the present disclosure;

FIG. 6 is a schematic cross-sectional view of a display panel having a light-transmitting area according to one embodiment of the present disclosure;

FIG. 7 is a schematic cross-sectional view of a display panel having a light-transmitting area according to one embodiment of the present disclosure;

FIG. 8 is a schematic cross-sectional view of a display panel having a light-transmitting area according to one embodiment of the present disclosure;

FIG. 9 is a schematic cross-sectional view of a display panel having a light-transmitting area according to one embodiment of the present disclosure;

FIG. 10 is a schematic cross-sectional view of a display panel having a light-transmitting area according to one embodiment of the present disclosure;

FIG. 11 is a schematic cross-sectional view of a display panel having a light-transmitting area according to one embodiment of the present disclosure;

FIG. 12 is a schematic cross-sectional view of a display panel having a light-transmitting area according to one embodiment of the present disclosure; and

FIG. 13 is a schematic cross-sectional view of a display panel having a light-transmitting area according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an,” and “the” includes plural reference, and the meaning of “in” includes “in” and “on.” Titles or subtitles can be used herein for the convenience of a reader, which shall not influence the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification, including examples of any terms, is illustrative only and in no way limits the scope and meaning of the present disclosure or any exemplified term. Likewise, the present disclosure is not limited to the various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

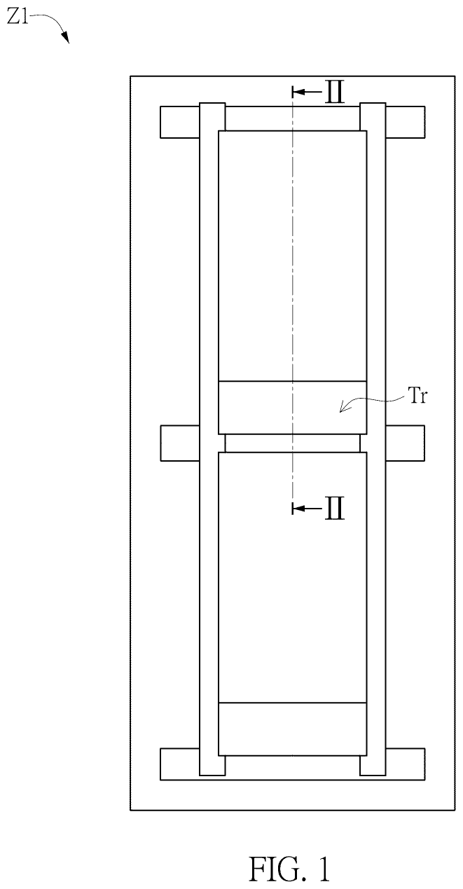

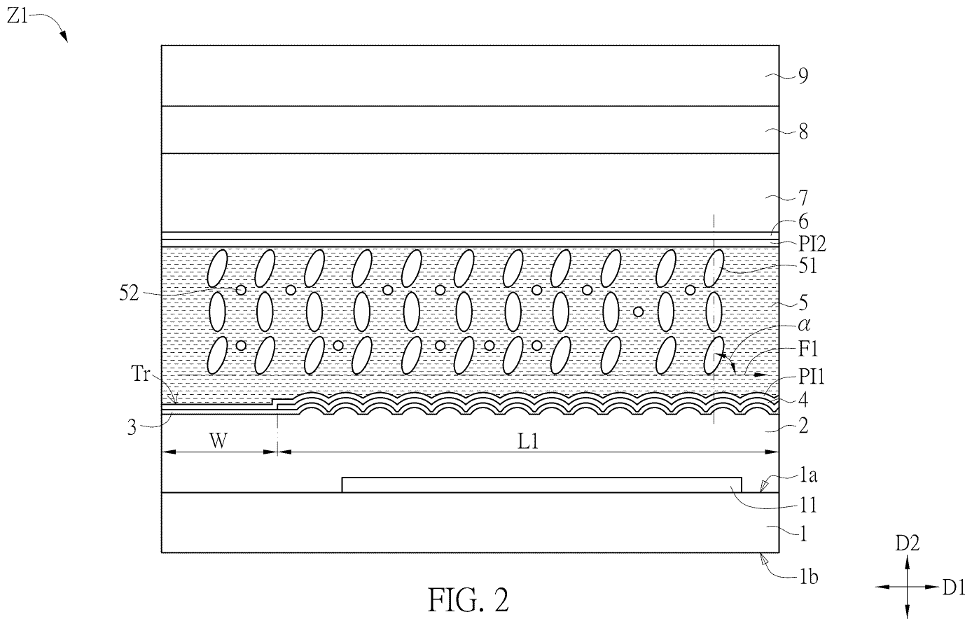

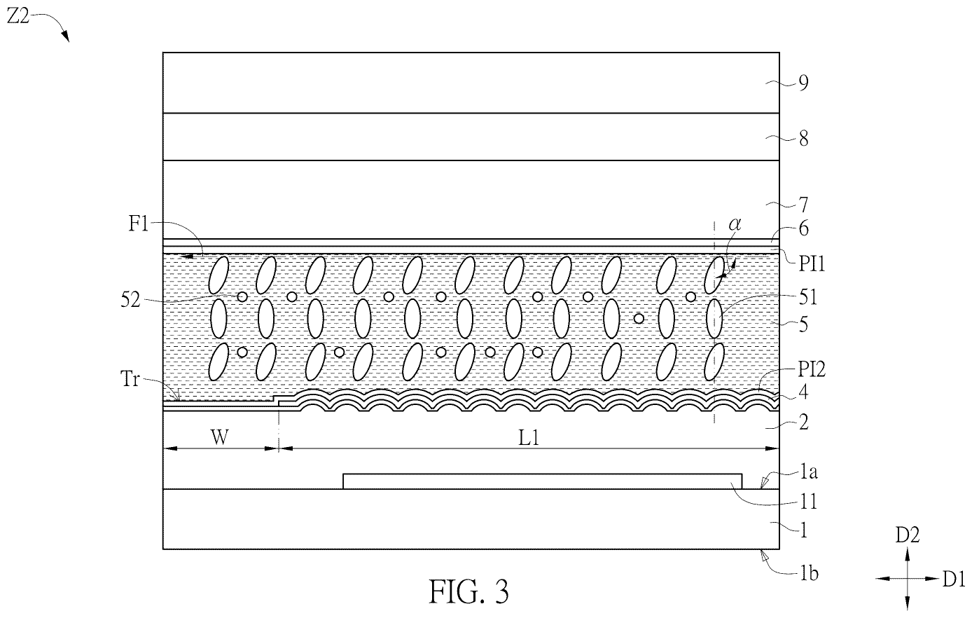

Reference is made to FIGS. 1 to 3. FIG. 1 is a schematic view of a pixel in a display panel having a light-transmitting area according to one embodiment of the present disclosure. FIG. 2 is a schematic cross-sectional view of a pixel shown in FIG. 1. FIG. 3 is a schematic cross-sectional view of the display panel having a light-transmitting area according to one embodiment of the present disclosure. A display panel Z1 having a light-transmitting area includes: a first light-transmitting substrate 1, a first flat layer 2, a first light-transmitting conductive layer 3, a reflective layer 4, a liquid crystal layer 5, a second light-transmitting conductive layer 6, a second flat layer 7, a color filter 8, a second light-transmitting substrate 9, and two alignment films. The two alignment films are referred to hereinafter as a first alignment film PI1, and a second alignment film PI2. When the first alignment film PI1 and the second alignment film PI2 are configured to apply a first directional force F1 and a second directional force F2, respectively, it indicates that the alignment films undergo an alignment process and possess a pre-tilt angle (not shown in the drawings). The first light-transmitting substrate 1 includes a top surface 1a and a bottom surface 1b. A thin film transistor (TFT) array 11 is disposed on the top surface 1a. The first flat layer 2 is disposed on the TFT array 11. The first light-transmitting conductive layer 3 is disposed on the first flat layer 2. The reflective layer 4 is disposed on the first light-transmitting conductive layer 3. A region of the first light-transmitting conductive layer 3 that does not include the reflective layer 4 defines a transmitting opening Tr. The liquid crystal layer 5 includes a plurality of liquid crystals 51 and is disposed on the reflective layer 4. Chiral molecules 52 are doped into the liquid crystal layer 5. The second light-transmitting conductive layer 6 is disposed on the liquid crystal layer 5. The second flat layer 7 is disposed on the second light-transmitting conductive layer 6. The color filter 8 is disposed on the second flat layer 7. The second light-transmitting substrate 9 is disposed on the color filter 8. Referring to FIG. 2, the first alignment film PI1 is disposed between the reflective layer 4 and the liquid crystal layer 5, and the second alignment film PI2 is disposed between the second light-transmitting conductive layer 6 and the liquid crystal layer 5. The first alignment film PI1 applies the first directional force F1 to the plurality of liquid crystals 51 in contact therewith. The surface of the first alignment film PI1 facing the liquid crystal layer 5 defines a contact surface, and each of the liquid crystals 51 subjected to the first directional force F1 forms a positioning angle α with the contact surface, as shown in FIG. 3.

In the display panel Z2 having a light-transmitting area shown in FIG. 3, the first alignment film PI1 is disposed between the second light-transmitting conductive layer 6 and the liquid crystal layer 5, and the second alignment film PI2 is disposed between the reflective layer 4 and the liquid crystal layer 5. According to the embodiments shown in FIGS. 2 and 3, no voltage is applied to the display panels Z1 and Z2. Therefore, the liquid crystals 51 subjected to the first directional force F1 form a positioning angle α with the contact surface. Through the action of at least one of the first directional force F1 or the second directional force F2 (described below), the positioning angle α formed between the liquid crystals and the contact surface is in a range of 70 to 110 degrees. This configuration helps prevent light leakage caused by the hysteresis of liquid crystals at the panel edges.

The first and second light-transmitting conductive layers 3 and 6, for example, are indium tin oxide (ITO). The reflective layer 4, for example, is a silver layer or an aluminum layer.

According to some embodiments, the width W of the transmitting opening Tr in the horizontal direction D1 is greater than 2 μm. According to other embodiments, the width W of the transmitting opening Tr in the horizontal direction D1 is equal to or less than the length L1 of the reflective layer 4. In the illustrated embodiment of the present disclosure, the width W of the transmitting opening Tr is less than the length L1 of the reflective layer 4. However, depending on product design requirements, the width W of the transmitting opening Tr may also be equal to the length L1 of the reflective layer 4.

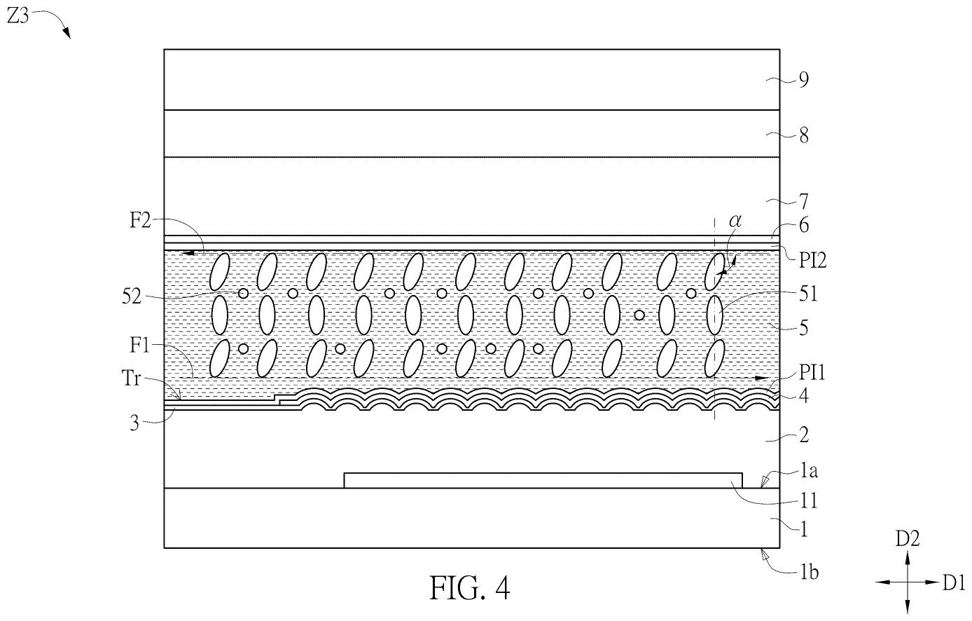

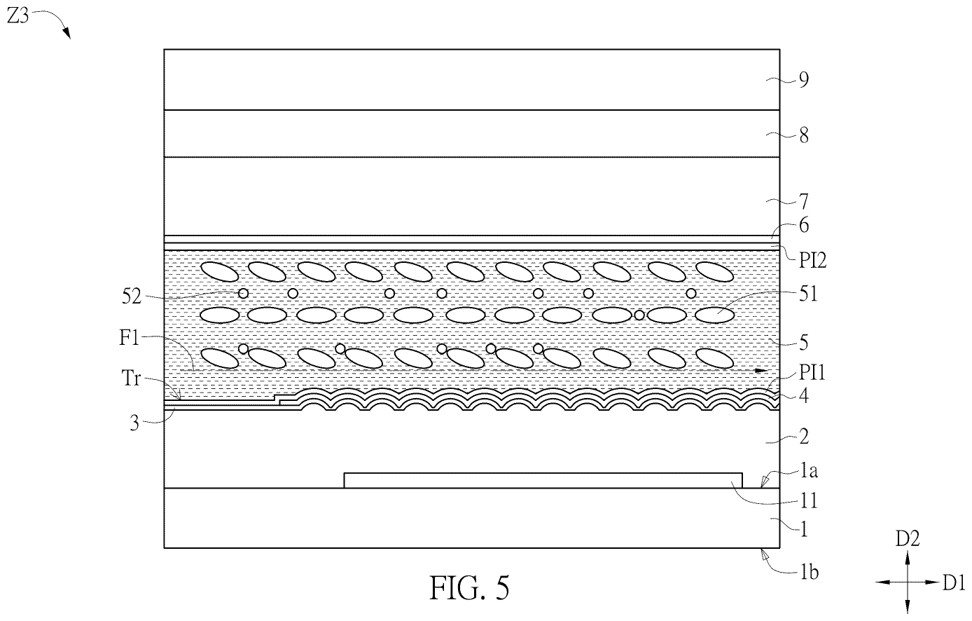

Reference is made to FIGS. 4 and 5, which are schematic cross-sectional views of a display panel having a light-transmitting area according to one embodiment of the present disclosure. FIG. 4 illustrates a display panel Z3 having a light-transmitting area in a state where no voltage is applied, while FIG. 5 illustrates the same display panel Z3 with voltage applied. In this embodiment, the first alignment film PI1 is disposed between the reflective layer 4 and the liquid crystal layer 5, and the second alignment film PI2 is disposed between the second light-transmitting conductive layer 6 and the liquid crystal layer 5. The second alignment film PI2 provides a second directional force F2 to the plurality of liquid crystals 51 in contact therewith. When no voltage is applied, each of the liquid crystals 51 subjected to the second directional force F2 forms a positioning angle α with the contact surface, as shown in FIG. 4. When voltage is applied, each liquid crystal 51 rotates to a state that is substantially parallel to the contact surface (i.e., the horizontal plane), as shown in FIG. 5.

According to some embodiments, an alignment angle is formed between the direction of the first directional force F1 and the direction of the second directional force F2. The alignment angle is greater than or equal to 0 degrees and less than or equal to 180 degrees. In other words, the directions of the first directional force F1 and the second directional force F2 may be the same, intersecting, or opposite. Such a configuration can be selected based on the desired initial alignment direction of the liquid crystals (for example, according to the liquid crystal material or the required optical effect).

In the present disclosure, the chiral molecules 52 form bonds with the liquid crystals and provide the liquid crystals with stable rotational alignment. The doping concentration of the chiral molecules 52 is defined based on the distance that each liquid crystal travels along the vertical direction D2 while rotating 360 degrees about the vertical axis D2. The range of the distance is from 1 to 100 μm. For example, if the doping concentration of the chiral molecules 52 causes a liquid crystal to rotate 90 degrees while traveling 4 μm along the vertical direction D2, then the total distance traveled for a full 360-degree rotation would be 16 μm. By doping the liquid crystal layer with chiral molecules 52, the liquid crystals can exhibit stable rotational capability.

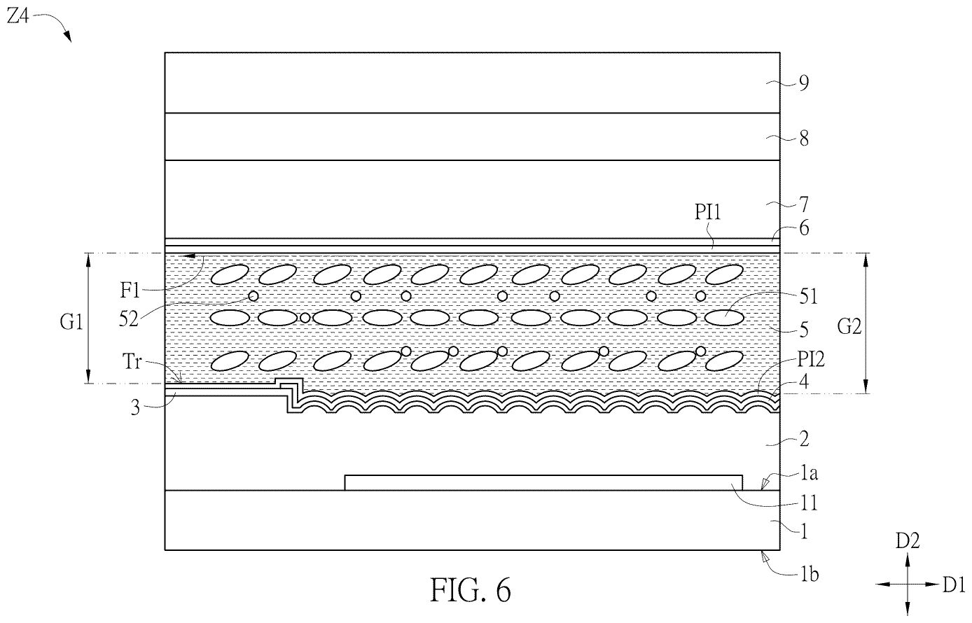

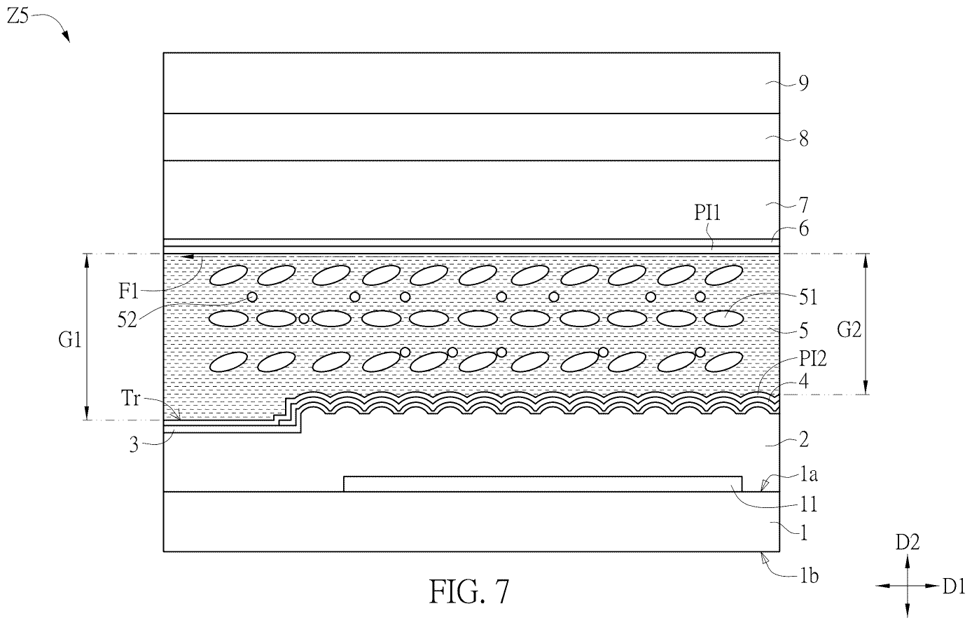

Reference is made to FIGS. 6 and 7, which are schematic cross-sectional views of display panels Z4 and Z5 with light-transmitting areas according to one embodiment of the present disclosure. In these embodiments, the first alignment film PI1 is disposed between the second light-transmitting conductive layer 6 and the liquid crystal layer 5, and the second alignment film PI2 is disposed between the reflective layer 4 and the liquid crystal layer 5. The first alignment film PI1 provides a first directional force F1 to the plurality of liquid crystals 51 in contact therewith. The difference between display panel Z4 and display panel Z5 lies in the structure of the first flat layer 2. As shown in FIG. 6, the first flat layer 2 includes a convex portion 21 corresponding to the transmitting opening Tr. A portion of the liquid crystal layer 5 corresponding to the convex portion 21 defines a first spacing G1 in the vertical direction D2. A portion of the liquid crystal layer 5 corresponding to the reflective layer 4 defines a second spacing G2 in the vertical direction D2. The ratio of the first spacing G1 to the second spacing G2 is less than 1 and greater than or equal to 0.33. In the embodiment shown in FIG. 7, the first flat layer 2 includes a concave portion 22 corresponding to the transmitting opening Tr. A portion of the liquid crystal layer 5 corresponding to the concave portion 22 defines the first spacing G1 in the vertical direction D2. A portion of the liquid crystal layer 5 corresponding to the reflective layer 4 defines the second spacing G2 in the vertical direction D2. The ratio of the first spacing G1 to the second spacing G2 is greater than 1 and less than or equal to 3.

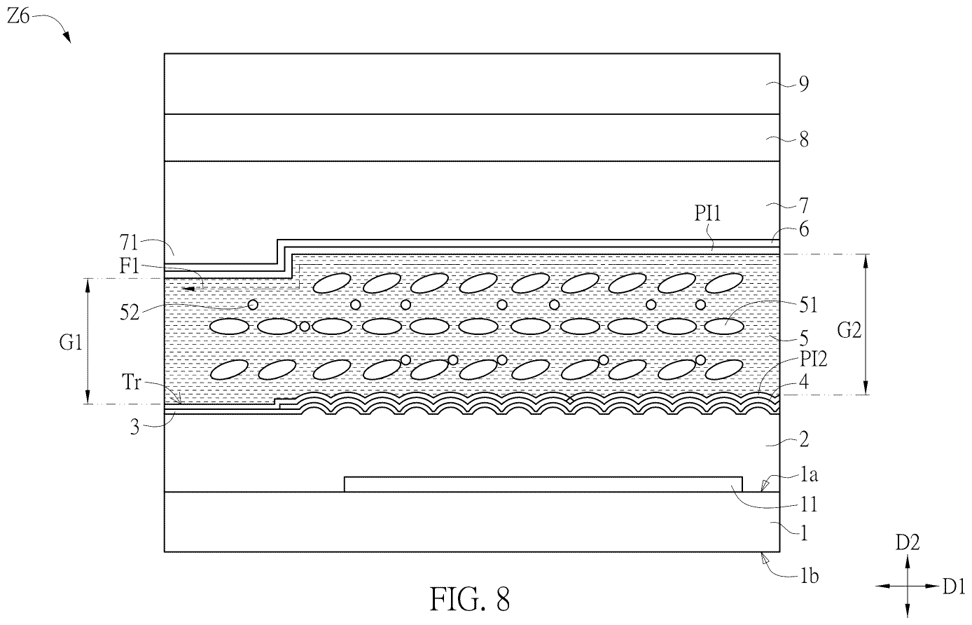

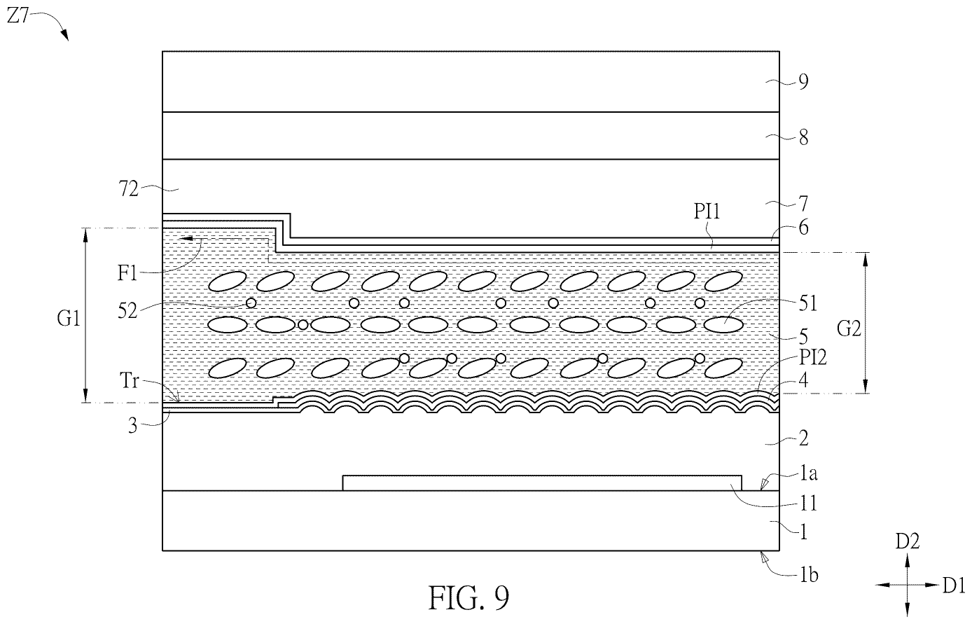

Reference is made to FIGS. 8 and 9, which are schematic cross-sectional views of display panels Z6 and Z7 with light-transmitting areas according to one embodiment of the present disclosure. In these embodiments, the first alignment film PI1 is disposed between the second light-transmitting conductive layer 6 and the liquid crystal layer 5, and the second alignment film PI2 is disposed between the reflective layer 4 and the liquid crystal layer 5. The first alignment film PI1 provides a first directional force F1 to the plurality of liquid crystals 51 in contact therewith. The difference between display panel Z6 and display panel Z7 lies in the structure of the second flat layer 7. As shown in FIG. 8, the second flat layer 7 includes a convex portion 71 corresponding to the transmitting opening Tr. A portion of the liquid crystal layer 5 corresponding to the convex portion 71 defines a first spacing G1 in the vertical direction D2. A portion of the liquid crystal layer 5 corresponding to the reflective layer 4 defines a second spacing G2 in the vertical direction D2. The ratio of the first spacing G1 to the second spacing G2 is less than 1 and greater than or equal to 0.33. As shown in FIG. 9, the second flat layer 7 includes a concave portion 72 corresponding to the transmitting opening Tr. A portion of the liquid crystal layer 5 corresponding to the concave portion 72 defines the first spacing G1 in the vertical direction D2. A portion of the liquid crystal layer 5 corresponding to the reflective layer 4 defines the second spacing G2 in the vertical direction D2. The ratio of the first spacing G1 to the second spacing G2 is greater than 1 and less than or equal to 3.

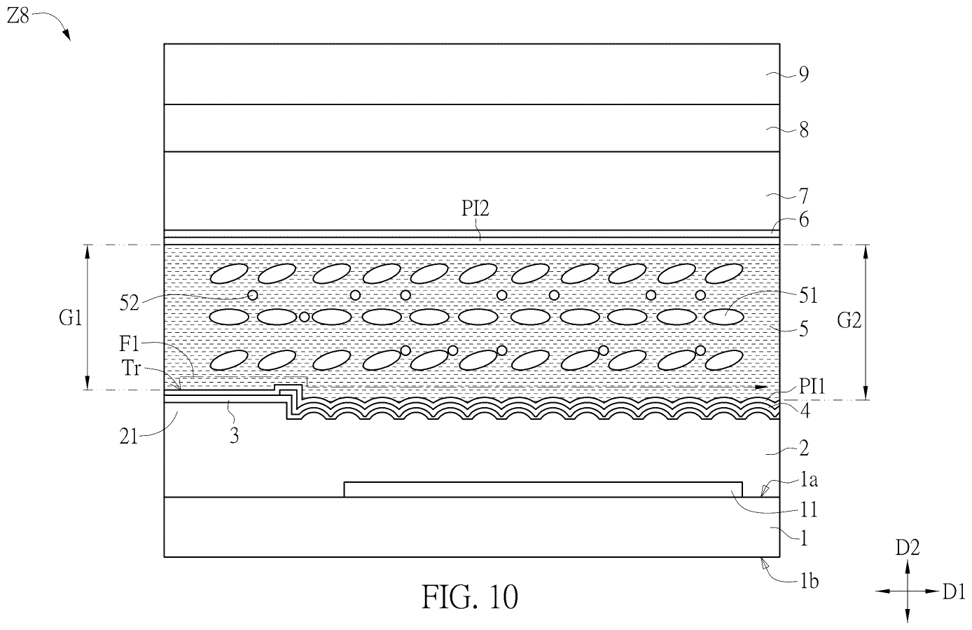

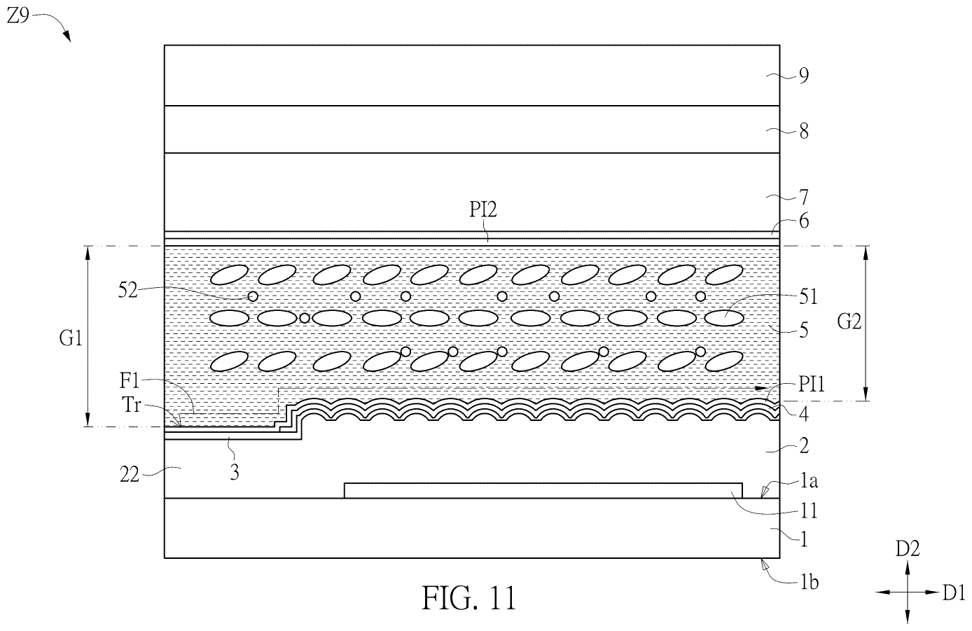

Reference is made to FIGS. 10 and 11, which are schematic cross-sectional views of display panels Z8 and Z9 with light-transmitting areas according to one embodiment of the present disclosure. In these embodiments, the first alignment film PI1 is disposed between the reflective layer 4 and the liquid crystal layer 5, and the second alignment film PI2 is disposed between the second light-transmitting conductive layer 6 and the liquid crystal layer 5. The first alignment film PI1 provides a first directional force F1 to the plurality of liquid crystals 51 in contact therewith. The difference between display panel Z8 and display panel Z9 lies in the structure of the first flat layer 2. As shown in FIG. 10, the first flat layer 2 includes a convex portion 21 corresponding to the transmitting opening Tr. A portion of the liquid crystal layer 5 corresponding to the convex portion 21 defines a first spacing G1 in the vertical direction D2. A portion of the liquid crystal layer 5 corresponding to the reflective layer 4 defines a second spacing G2 in the vertical direction D2. The ratio of the first spacing G1 to the second spacing G2 is less than 1 and greater than or equal to 0.33. As shown in FIG. 11, the first flat layer 2 includes a concave portion 22 corresponding to the transmitting opening Tr. A portion of the liquid crystal layer 5 corresponding to the concave portion 22 defines the first spacing G1 in the vertical direction D2. A portion of the liquid crystal layer 5 corresponding to the reflective layer 4 defines the second spacing G2 in the vertical direction D2. The ratio of the first spacing G1 to the second spacing G2 is greater than 1 and less than or equal to 3.

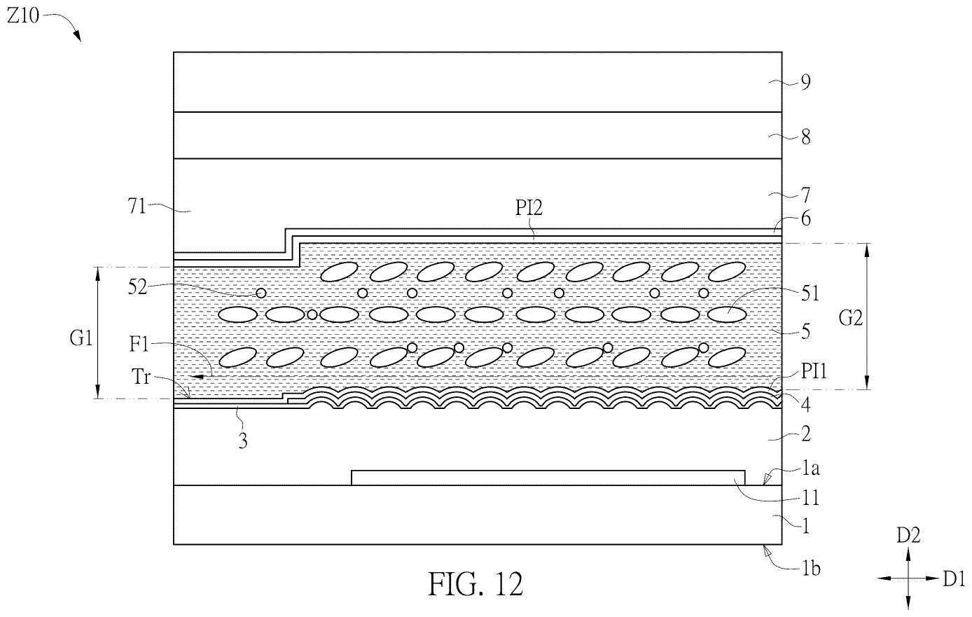

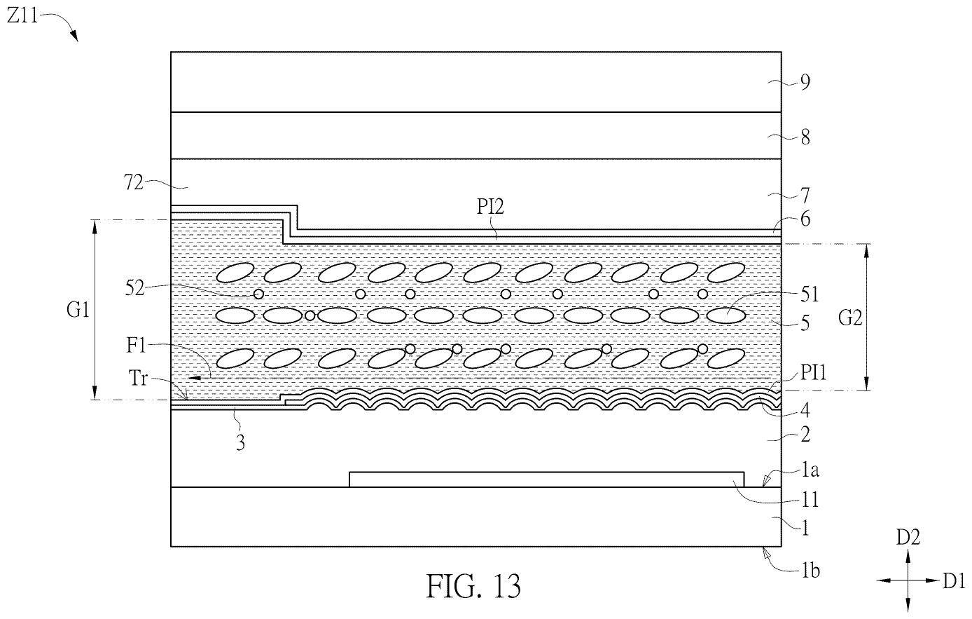

Reference is made to FIGS. 12 and 13, which are schematic cross-sectional views of display panels Z10 and Z11 with light-transmitting areas according to one embodiment of the present disclosure. In these embodiments, the first alignment film PI1 is disposed between the reflective layer 4 and the liquid crystal layer 5 and provides the first directional force F1. The second alignment film PI2 is disposed between the second light-transmitting conductive layer 6 and the liquid crystal layer 5. The difference between display panel Z10 and display panel Z11 lies in the structure of the second flat layer 7. As shown in FIG. 12, the second flat layer 7 includes a convex portion 71 corresponding to the transmitting opening Tr. A portion of the liquid crystal layer 5 corresponding to the convex portion 71 defines a first spacing G1 in the vertical direction D2. A portion of the liquid crystal layer 5 corresponding to the reflective layer 4 defines a second spacing G2 in the vertical direction D2. The ratio of the first spacing G1 to the second spacing G2 is less than 1 and greater than or equal to 0.33. As shown in FIG. 13, the second flat layer 7 includes a concave portion 72 corresponding to the transmitting opening Tr. A portion of the liquid crystal layer 5 corresponding to the concave portion 72 defines the first spacing G1 in the vertical direction D2. A portion of the liquid crystal layer 5 corresponding to the reflective layer 4 defines the second spacing G2 in the vertical direction D2. The ratio of the first spacing G1 to the second spacing G2 is greater than 1 and less than or equal to 3.

According to some embodiments, polarizers may be disposed outside the first light-transmitting substrate 1 and the second light-transmitting substrate 9 (not shown in the drawings). The polarizer may be a biaxial polarizer or a triaxial polarizer. In some embodiments, the polarizer is a four-axis polarizer (+½λ, +½λ, +¼λ). By providing the polarizers, the issue of poor visual performance at certain viewing angles can be addressed.

One of the beneficial effects of the present disclosure is that the display panel having a light-transmitting area is based on the technical scheme in which “a reflective layer being disposed on the first light-transmitting conductive layer, and a region of the first light-transmitting conductive layer that is not covered by the reflective layer defining a transmission opening,” and “two alignment films being respectively disposed between the reflective layer and the liquid crystal layer, and between the second light-transmitting conductive layer and the liquid crystal layer, wherein at least one of the alignment films has a pre-tilt angle to apply a first directional force to the liquid crystals in contact therewith.” With such a configuration, even in an extremely narrow light-transmitting area, the initial alignment of the liquid crystals can be effectively controlled by the first directional force provided by the first alignment film. As a result, vertically aligned liquid crystal display panels no longer require protrusions for alignment, thereby overcoming the issue of poor alignment performance, especially for liquid crystals located within the transmission area. In addition, the configuration eliminates the problem of light obstruction caused by protrusions in the transmission area, thereby improving the transmittance of the panel.

Furthermore, the liquid crystal layer of the display panel having a light-transmitting area is doped with chiral molecules. By incorporating chiral molecules, the liquid crystals can exhibit stable rotational behavior.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A display panel having a light-transmitting area, comprising:
a first light-transmitting substrate including a top surface and a bottom surface, a thin film transistor array being disposed on the top surface;
a first flat layer disposed on the thin film transistor array;
a first light-transmitting conductive layer disposed on the first flat layer;
a reflective layer disposed on the first light-transmitting conductive layer, a region on the first light-transmitting conductive layer that does not have the reflective layer defining a transmitting opening;
a liquid crystal layer including a plurality of liquid crystals, the liquid crystal layer being disposed on the reflective layer, and the liquid crystal layer being doped with chiral molecules;
a second light-transmitting conductive layer disposed on the liquid crystal layer;
a second flat layer disposed on the second light-transmitting conductive layer;
a filter disposed on the second flat layer;
a second light-transmitting substrate disposed on the filter; and
two alignment films being respectively disposed between the reflective layer and the liquid crystal layer, and between the second light-transmitting conductive layer and the liquid crystal layer;
wherein at least one of the two alignment films has a pre-tilt angle to provide a first directional force to the plurality of liquid crystals in contact therewith.

2. The display panel having a light-transmitting area according to claim 1, wherein the surface of the alignment film exerting the first directional force toward the liquid crystal layer defines a contact surface, and the plurality of liquid crystals exerting the first directional force respectively have a positioning angle with the contact surface, and the positioning angle is 70 to 110 degrees.

3. The display panel having a light-transmitting area according to claim 1, wherein another alignment film has another pre-tilt angle to provide a second directional force to the plurality of liquid crystals in contact therewith.

4. The display panel having a light-transmitting area according to claim 3, wherein an alignment angle is formed between the first directional force and the second directional force, and the alignment angle is greater than or equal to 0 degrees and less than or equal to 180 degrees.

5. The display panel having a light-transmitting area according to claim 1, wherein a width of the transmitting opening in a horizontal direction is greater than 2μm.

6. The display panel having a light-transmitting area according to claim 1, wherein, in a horizontal direction, a width of the transmitting opening is less than or equal to a length of the reflective layer.

7. The display panel having a light-transmitting area according to claim 1, wherein a doping concentration of the chiral molecules is defined by a distance that each of the liquid crystals moves along the vertical direction when rotating 360 degrees with the vertical direction as the rotation axis, and a range of the distance is 1 to 100μm.

8. The display panel having a light-transmitting area according to claim 1, wherein the two alignment films respectively define a first alignment film and a second alignment film, the first alignment film is located between the second light-transmitting conductive layer and the liquid crystal layer, the first alignment film applies the first directional force, the first flat layer has a convex portion corresponding to the transmitting opening;
wherein a portion of the liquid crystal layer corresponding to the convex portion defines a first spacing in thickness in a vertical direction; and
wherein a portion of the liquid crystal layer corresponding to the reflective layer has a thickness in the vertical direction defining a second spacing, and a ratio of the first spacing to the second spacing is less than 1 and greater than or equal to 0.33.

9. The display panel having a light-transmitting area according to claim 1, wherein the two alignment films respectively define a first alignment film and a second alignment film, the first alignment film is located between the second light-transmitting conductive layer and the liquid crystal layer, the first alignment film applies the first directional force, the first flat layer has a concave portion corresponding to the transmitting opening;
wherein a portion of the liquid crystal layer corresponding to the concave portion has a thickness in a vertical direction defining a first spacing; and
wherein a portion of the liquid crystal layer corresponding to the reflective layer defines a second spacing in thickness in the vertical direction, and the ratio of the first spacing to the second spacing is greater than 1 and less than or equal to 3.

10. The display panel having a light-transmitting area according to claim 1, wherein the two alignment films respectively define a first alignment film and a second alignment film, the first alignment film is located between the second light-transmitting conductive layer and the liquid crystal layer, the first alignment film applies the first directional force, the second flat layer has a convex portion corresponding to the transmitting opening;
wherein a portion of the liquid crystal layer corresponding to the convex portion has a thickness in a vertical direction defining a first spacing; and
wherein a portion of the liquid crystal layer corresponding to the reflective layer defines a second spacing in thickness in the vertical direction, and the ratio of the first spacing to the second spacing is less than 1 and greater than or equal to 0.33.

11. The display panel having a light-transmitting area according to claim 1,
wherein the two alignment films respectively define a first alignment film and a second alignment film, the first alignment film is located between the second light-transmitting conductive layer and the liquid crystal layer, the first alignment film applies the first directional force, the second flat layer has a concave portion corresponding to the transmitting opening;
wherein a portion of the liquid crystal layer corresponding to the concave portion has a thickness in a vertical direction defining a first spacing; and
wherein a portion of the liquid crystal layer corresponding to the reflective layer defines a second spacing in thickness in the vertical direction, and a ratio of the first spacing to the second spacing is greater than 1 and less than or equal to 3.

12. The display panel having a light-transmitting area according to claim 1, wherein the two alignment films respectively define a first alignment film and a second alignment film, the first alignment film is located between the reflective layer and the liquid crystal layer, the first alignment film applies the first directional force, the first flat layer has a convex portion corresponding to the transmitting opening;
wherein a portion of the liquid crystal layer corresponding to the convex portion has a thickness in a vertical direction defining a first spacing; and
wherein a portion of the liquid crystal layer corresponding to the reflective layer defines a second spacing in thickness in the vertical direction, and a ratio of the first spacing to the second spacing is less than 1 and greater than or equal to 0.33.

13. The display panel having a light-transmitting area according to claim 1,
wherein the two alignment films respectively define a first alignment film and a second alignment film, the first alignment film is located between the reflective layer and the liquid crystal layer, the first alignment film applies the first directional force, the first flat layer has a concave portion corresponding to the transmitting opening;
wherein a portion of the liquid crystal layer corresponding to the concave portion has a thickness in a vertical direction defining a first spacing; and
wherein a portion of the liquid crystal layer corresponding to the reflective layer defines a second spacing in thickness in the vertical direction, and the ratio of the first spacing to the second spacing is greater than 1 and less than or equal to 3.

14. The display panel having a light-transmitting area according to claim 1,
wherein the two alignment films respectively define a first alignment film and a second alignment film, the first alignment film is located between the reflective layer and the liquid crystal layer, the first alignment film applies the first directional force, the second flat layer has a convex portion corresponding to the transmitting opening;
wherein a portion of the liquid crystal layer corresponding to the convex portion has a thickness in a vertical direction defining a first spacing; and
wherein a portion of the liquid crystal layer corresponding to the reflective layer defines a second spacing in thickness in the vertical direction, and the ratio of the first spacing to the second spacing is less than 1 and greater than or equal to 0.33.

15. The display panel having a light-transmitting area according to claim 1,
wherein the two alignment films respectively define a first alignment film and a second alignment film, the first alignment film is located between the reflective layer and the liquid crystal layer, the first alignment film applies the first directional force, the second flat layer has a concave portion corresponding to the transmitting opening; wherein a portion of the liquid crystal layer corresponding to the concave portion defines a first spacing in a thickness in a vertical direction; and wherein a portion of the liquid crystal layer corresponding to the reflective layer defines a second spacing in thickness in the vertical direction, and the ratio of the first spacing to the second spacing is greater than 1 and less than or equal to 3.
